(19) United States
(12) Patent Application Publication
(10) Pub. No.: US 2022/0342985 A1
(43) Pub. Date: Oct. 27, 2022

(54) ANOMALY DETECTION AND CHARACTERIZATION IN APP PERMISSIONS

(71) Applicant: Avast Software s.r.o., Prague 4 (CZ)

(72) Inventors: Galina Alperovich, Prague (CZ); Otakar Jasek, Brno (CZ)

(73) Assignee: Avast Software s.r.o., Prague 4 (CZ)

(21) Appl. No.: 17/238,854

(22) Filed: Apr. 23, 2021

(51) Int. Cl. G06F 21/55; G06F 21/62

(52) U.S. Cl. CPC G06F 21/552; G06F 21/6218; G06F 2221/033

(57) ABSTRACT

Anomalous or unexpected system permissions in applications in a computing environment are identified by generating a statistical model at least in part from application permissions granted across a plurality of application types. One or more of the application permissions granted across a plurality of application types are identified as potentially unexpected dangerous permissions. The statistical model is used to determine whether a target application has at least one potentially dangerous permission that is not statistically likely for a target application type of the target application.

### FIELD

The invention relates generally to managing security in installed applications or apps, and more specifically to anomaly detection and characterization in app permissions.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, such as running file sharing programs or transmitting corporate secrets from within the corporation's network to the Internet.

For these and other reasons, many computer systems employ a variety of safeguards designed to protect computer systems against certain threats. Firewalls are designed to restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, website scanning tools are used to verify the security and integrity of a website, and to identify and fix potential vulnerabilities.

For example, a firewall in a home or office may restrict the types of connection and the data that can be transferred between the internal network and an external or public network such as the Internet, based on firewall rules and characteristics of known malicious data. Similarly, antimalware software on a personal computer or smart phone may monitor applications installed on the device, network traffic to and from the device, and files such as stored executable code or configuration settings that pose a threat to the device.

Smart phones have addressed user control over app behavior by structuring their operating systems to require apps to request permissions be configured to access certain privacy or security-related functions, such as location, microphone, camera, accessing a fingerprint reader or other authentication device, changing device configuration, and the like. But, users are frequently unaware of what permissions any particular application has been granted, and are often not motivated to seek out such information unless a specific problem has already been experienced.

Improved handling of app permissions in a computing environment such as a smart phone is therefore desired.

### SUMMARY

In one example embodiment, anomalous or unexpected system permissions in applications in a computing environment are identified by generating a statistical model at least in part from application permissions granted across a plurality of application types. One or more of the application permissions granted across a plurality of application types are identified as potentially dangerous permissions. The statistical model is used to determine whether a target application has at least one potentially dangerous permission that is not statistically likely for a target application type of the target application.

In a further example, the determination of whether a target application has at least one unexpected potentially dangerous permission that is not statistically likely comprises metric or score indicating the degree of statistically unlikely dangerous permissions for the target application. The metric in some examples is indicated to the user. In another example, the identity of the anomalous potentially dangerous permission in the target application is presented to the user.

The details of one or more examples of the invention are set forth in the accompanying drawings and the description below. Other features and advantages will be apparent from the description and drawings, and from the claims.

### BRIEF DESCRIPTION OF THE DRAWINGS

FIG. 1 shows a network with a smart phone having anomalous system permission detection for apps, consistent with an example embodiment.

FIG. 2 shows a more detailed example of smart phone 110, consistent with an example embodiment.

FIG. 3 shows the five permissions having the highest TF-IDF scores for several app categories, consistent with an example embodiment.

FIG. 4 shows calculation of an app anomaly score, consistent with an example embodiment.

FIG. 5 is a flowchart of a method of determining whether a target app has anomalous permissions, consistent with an example embodiment

FIG. 6 is a computerized smart phone, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to computers to steal, delete, or change information, or to encrypt the information and hold it for ransom via “ransomware.” Smartphone apps, Microsoft® Word documents containing macros, Java™ applets, and other such common documents are all frequently infected with malware of various types, and so users rely on tools such as antivirus software or other malware protection tools to protect their computerized devices from harm.

An increasing number of computerized devices such as home appliances, vehicles, and other devices are connected to public networks and are also susceptible to unauthorized interception or modification of data. For example, many most smart phones run applications or apps specifically designed for the phone's operating system by third parties, which occasionally contain malware or include features that access sensitive user data such as contacts, geographic location, microphone or camera, and the like. Similar vulnerabilities are known to exist or may exist in many other such devices, including smart televisions, digital assistant appliances, and other computerized devices.

Some devices attempt to manage undesired behavior of third-party apps by providing an operating system interface to allow, view, or otherwise manage permissions requested or used by installed or executing applications. For example, many smart phones require the user to consent to a new app's attempt to use geographic location, access contacts, or use the camera or microphone, and provide a mechanism to review and change the permissions previously granted to installed apps. But, such permissions authorization systems rely on a user to make savvy determinations about the permissions granted to an app, often without knowing whether such permissions are really necessary for an app to perform the functions the user desires. Further, such systems rely on the user to determine the degree to which some permissions, such as accessing the user's location, are more invasive to a user's privacy than other permissions, such as setting a wallpaper image on the device. Many users do not understand or take the time to manage app permissions, automatically accepting app permission requests without taking the time to understand or consider the impact such a decision has on their privacy or personal information.

Some example embodiments of the invention presented herein therefore provide for detection and explanation of anomalous system permission requests in apps. In a more detailed example, an app (such as a navigation app) that requests sensitive permissions that are not customary for that type of app (such as a navigation app requesting access to the camera and microphone) will be flagged as anomalous, and brought to the user's attention. In a further example, the reason for the anomaly will be presented to the user, such as by explaining that the app identified itself as a navigation app but appears to be requesting anomalous sensitive permissions, such as camera and microphone access, more characteristic of a social media app. The user can then choose to let the app permissions remain as they are, or to amend them such as by removing permissions that are atypical for that type of application or uninstalling the application.

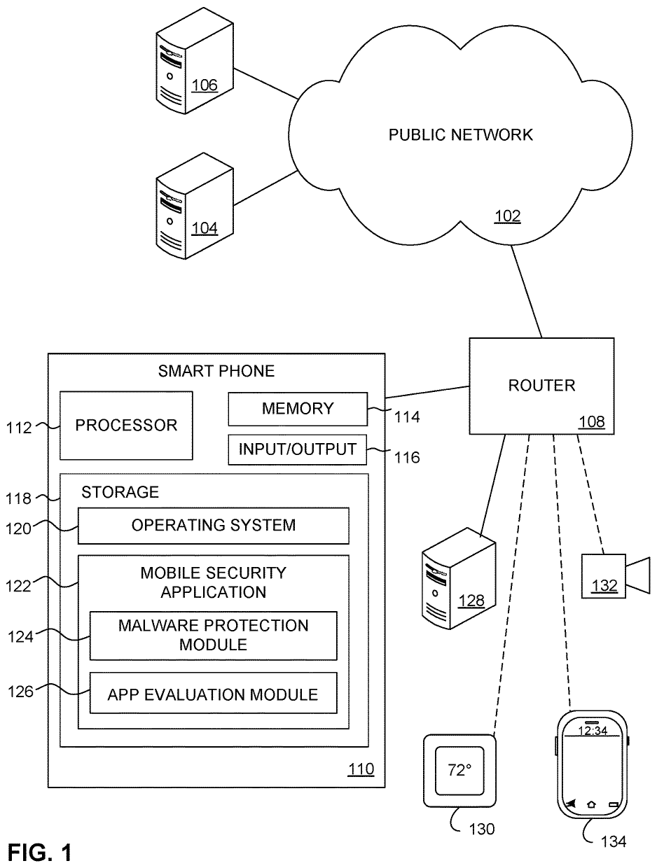

FIG. 1 shows a network with a smart phone having anomalous system permission detection for apps, consistent with an example embodiment. Here, a public network 102 such as the Internet couples remote servers such as 104 and 106 to a user's local network via router 108. The local network in this example includes a smart phone 110, which has a processor 112 operable to execute program instructions, a memory 114 operable to store program instructions and other data during execution, and input/output 116 such as a network connection. Storage 118 stores program instructions such as operating system 120, other installed apps or applications, and mobile security application 122. The mobile security application 122 includes malware protection module 124 that is operable when executed to search for and prevent execution of malicious program instructions, and app evaluation module 126 that is operable to evaluate characteristics of installed applications. Similar mobile security applications 122 and/or app evaluation modules 126 are in a further example executed on other computerized devices, such as computer 128, appliances such as smart thermostat 130, networked home security camera 132, or smart phone 134.

In operation, the mobile security application 122 uses its malware protection module 124 to examine program instructions for known or potentially malicious code, such as by examining executable files stored on storage 118, executable program instructions loaded into memory 114, and/or executable instructions received via a network connection such as input/output 116. The app evaluation module 126 also provides enhanced security and privacy for the smart phone 110 by evaluating apps or applications installed on smart phone 110 (such as by being stored in storage 118 and configured to execute via its operating system 120) for permissions the app requests from operating system 120, such as access to hardware devices such as a camera, microphone, or GPS location, or to access certain functions of the smart phone such as a fingerprint reader or phone operating state. If the requested permissions appear to be atypical of the type of application being evaluated, one or more actions such as suppressing execution of the app or notifying the user of the smart phone are taken.

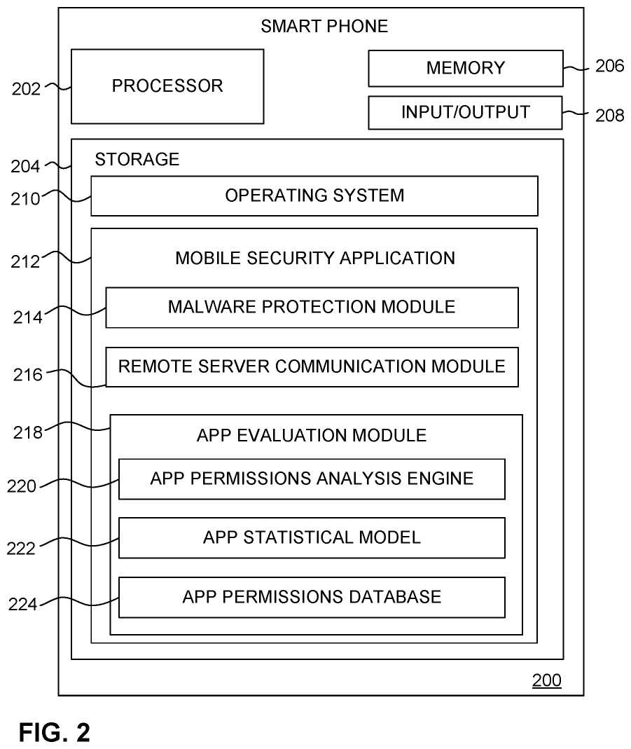

FIG. 2 shows a more detailed example of smart phone 110 at 200, including processor 202, storage 204, memory 206, and input/output 208. Storage 204 contains machine-readable instructions including operating system 210 and mobile security application 212. The mobile security application again includes malware protection module 214, as well as app evaluation module 218. Remote server communication module 216 enables the mobile security application to download and update data such as malware profiles or signatures and statistics for app permissions. The app evaluation module 218 includes an app permission analysis engine 220 that is operable to analyze the permissions an app has requested and determine whether the requested permissions are anomalous for the claimed application type. App statistical model 222 is used to determine whether permissions in a target app are anomalous, and in this example is received from a remote server using the remote server communication module 216. App permissions database 224 includes in this example permissions requested by each of the apps (or a subset of the apps) installed on the smart phone, and in a further example contains permissions characteristic of different application types for use with statistical model 222. App permission analysis engine 220 is operable to use the app permission database 224 and app statistical model 222 to determine whether a target app's requested permissions are typical of the target app's type, or are anomalous when compared with other apps of the target app's claimed app type.

In a more detailed example, app permission that are anomalous or atypical for a particular application type are identified by analyzing permissions granted across different types of applications to form a statistical model of app permissions that are likely and unlikely to be requested for various application types. The permissions are further characterized as being potentially dangerous or not, such as potentially dangerous permissions that reveal the smart phone's geographic location or allow the app to record audio or video using the smart phone.

If a potentially dangerous permission that is anomalous or statistically unlikely for a particular app type is requested by an app of that type, one or more actions are taken such as notifying a user of the anomalous permission and app, asking the user to manually confirm the permission for the app, blocking the permission for the app until reviewed and/or approved by the user, or other such actions. In a more detailed example, notification to the user includes a metric or score that indicates a degree to which the identified potentially dangerous permission is anomalous for the application type, such as by using the generated statistical model. In another example, another type of explanation as to why the app permissions are considered anomalous is presented, such as explaining the types of permissions typically requested by the app type in comparison to the permissions actually requested by the target or anomalous app. Explanations in some examples include a total anomaly score for the app, and in other examples include anomaly scores for anomalous permissions, all permissions, the top five most anomalous permissions, or the like.

The statistical model in some examples includes a threshold probability or likelihood that a particular app type may legitimately make use of a particular type of permission, such as a threshold likelihood or correlation between different permissions. For example, a banking app may have a high probability of using a fingerprint reader to authenticate users and a high probability of using the camera to photograph checks for mobile deposits, but a low probability of needing access to the microphone. Further, although there is a high correlation between apps accessing the camera and accessing the microphone among other types of apps, such a correlation is low enough in banking apps that microphone and camera permissions are not strongly statistically related. A banking app requesting permission for microphone use would therefore be considered anomalous, as its statistical likelihood will probably fail to exceed a threshold (for example, requested by 20% or more of banking/finance apps) and does not correlate strongly enough with requested or approved camera access for the app type to be considered strongly related to an approved permission.

Development of the statistical model in one example comprises observing the presence or absence of various application permissions across different application types. Because an end user device such as smart phone 110 will typically not have a statistically large sample of apps across a variety of application types installed, such statistics are in some examples evaluated via a remote server such as 104 that evaluates apps available from an app store or other such resource. The actual statistical model can take many forms in various embodiments, but in one example uses a Term Frequency-Inverse Document Frequency (TF-IDF) algorithm to characterize how characteristic various permissions are for different app categories.

TF-IDF processing is often used in text processing to determine how important a word is to a document from among a collection of documents. This is achieved by evaluating both how often the word occurs in the document being evaluated and how unique the document is in including the word from among the collection of documents. For example, a collection of general documents may frequently include words such as “the” and “and,” but not the words “medical” or “health,” which are more uniquely suggestive of the content of medical documents. Similarly, terms such as “cardiac,” “aorta,” or “tachycardia” may help identify medical documents that are specifically about heart health, while other common heart health terms such as “atrium” may suggest a medical or architectural document and “valve” may suggest a medical or plumbing document. TF-IDF analysis therefore helps characterize not only how common a term is in an object relative to a group of objects, but how unique the object is in having that term among the group of objects.

In a more detailed example, a TF-IDF score for each permission in each category can be determined using a weighted formula such as:

$${tf}_{idf ( P , C )} = ( share of apps with P in C ) * log \frac{1}{\begin{matrix}share of apps with P in all \\ categories except C\end{matrix}}$$

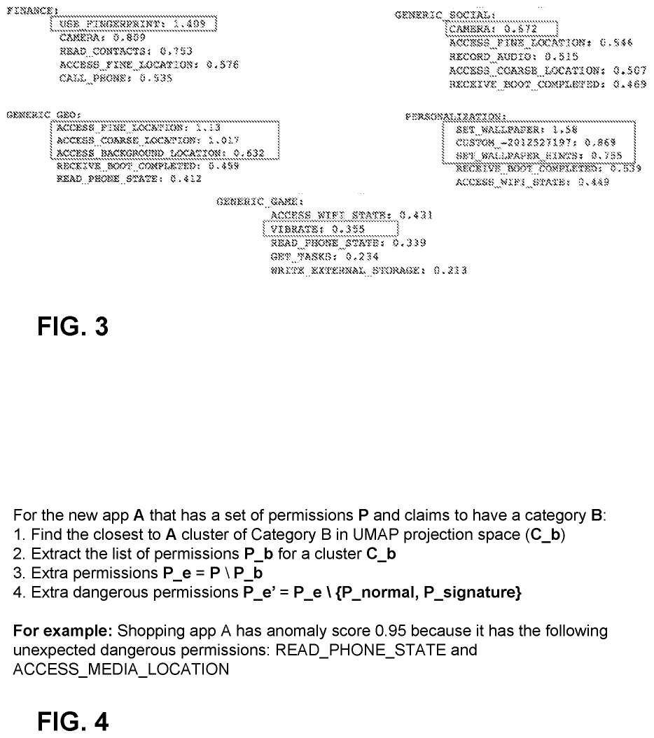

This formula essentially multiples the permission frequency of a permission P in an app category C by the logarithm of the inverse category frequency of the permission P in the category C. A TF-IDF permission score for each permission in each app category can then be calculated as shown in FIG. 3. FIG. 3 shows the five permissions having the highest TF-IDF scores for several app categories, consistent with an example embodiment. Here, the Finance app category shows using fingerprint permissions as the most-requested permission and having a score of 1.409, which is relatively high among app permissions shown. Camera permissions for finance apps are 0.809, and are significantly less likely than fingerprint permissions but still often used in finance apps. Other app categories such as generic games have no individual permission that are as frequently requested or as uniquely characteristic of game apps as the to five finance app permissions, with accessing WiFi state as the top permission with a score of 0.431. The last of the top five permissions for a generic game is writing external storage at 0.213, which is the lowest TF-IDF app category permission score in this example.

From these scores, use of the fingerprint reader is very common for finance apps, and should likely be allowed as being characteristic of that app type. Fingerprint reader use is relatively uncommon for other app categories, however, and should probably be disallowed by default or a notification given to the user if requested for a generic game app. Further, use of permissions such as a fingerprint reader and camera for a generic game app may suggest that the app has been miscategorized and should be a finance app. Similarly, the use of fine, coarse, and background location in an app may suggest that the app is a generic geo app, and should likely be allowed by default for apps claiming to be a geographic app such as a GPS mapping or navigation app. Anomaly scores in some examples therefore include determination of whether a target app's permissions appear more characteristic of another app type than the claimed app type as a way of determining that the target app has unexpected or anomalous permissions.

FIG. 4 shows calculation of an app anomaly score, consistent with an example embodiment. Generally, the output anomaly score is derived from the probability that the target app is in a category other than the claimed app category (determined using the derived statistical model). In further examples, this probability is modified by other factors such as the probability of detection or the probability of the target app being in the claimed category. In a more detailed example, an anomaly score other than zero means the target app A is predicted to be in a different app category than the claimed app category B based on its permissions P.

The unexpected permissions are derived as an explanation in this example using Uniform Manifold Approximation and Projection (UMAP), using the steps shown in FIG. 4. In a preferred embodiment, and HDB SCAN or other clustering algorithm is further applied after the UMAP step. Here, the closest claimed app category cluster C_b to the new app A is found in step one, and the list of permissions P_b for the cluster C_b is extracted in step two. The permissions determined to be extra permissions P_e′ are derived by determining which permissions from set P are not a part of the extracted list of permissions P_b at step 3, and the permissions determined to be potentially dangerous P_e′ are selected from the extra permissions P_e at step four. These dangerous, extra permissions are then presented to the user in some examples as part of an explanation as to why an app has been determined to have anomalous dangerous permissions. In the example of FIG. 4, a shopping application A has an anomaly score of 0.95 because it has requested unexpected dangerous permissions P_e′ of READ_PHONE_STATE and ACCESS_MEDIA_LOCATION.

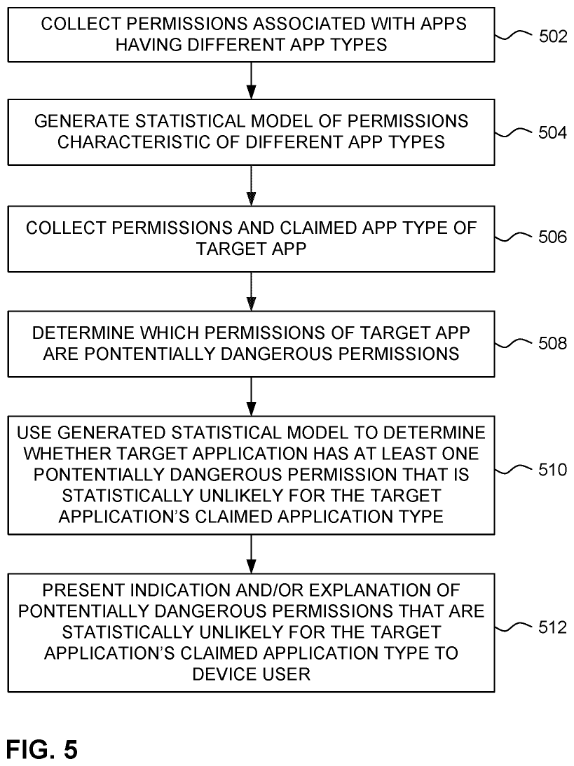

FIG. 5 is a flowchart of a method of determining whether a target app has anomalous permissions, consistent with an example embodiment. At 502, a remote server or other device collects permissions associated with apps having different app types, such as by downloading a large number of apps from an app store and evaluating the apps. In various examples, this includes downloading at least a certain number of apps for each app category (such as the top 100 apps in each category), downloading the top apps across all apps in the app store (such as the top 5000 apps), or another such measure to ensure that a variety of apps across a variety of categories are represented. A statistical model of permissions associated with apps in each app category is generated at 504, such as by using TF-IDF (Term Frequency- Inverse Document Frequency), UMAP, or other such statistical methods. Once the statistical model is assembled, it can be distributed to end user devices such as smart phone 110 or other end user devices such as those shown at 128-134 in FIG. 1.

At 506, the process of starting analyzing a target application on the smart phone is started by collecting the permissions and the claimed application type of the target app. The permissions are determined in this example by observing which permissions the app requests from the operating system (or which permissions the operating system has granted to the app), and the claimed application type is based on information such as the classification of the app in the smart phone's app store or through other such means. The collected permissions are evaluated at 508 to determine which of the permissions are potentially dangerous, such as permissions that reveal personal information about a user to the app or that allow the app to change operation or configuration of the smart phone (outside of the application's own settings).

At 510, the smart phone's app evaluation module uses the generated statistical model to determine whether the target application has at least one dangerous permission that is statistically unlikely for the target application's claimed application type, such as by using the statistical methods of FIGS. 3 and 4. If a dangerous permission atypical of the claimed application type is found, an action is taken, such as presenting an indication and/or explanation of the potentially dangerous permission that is statistically unlikely for the target application's claimed app type to a user of the smart phone at 512. In other examples, the user will be asked to confirm enabling the potentially dangerous permission, or the potentially dangerous permission will be disabled until or unless the user changes the permission settings.

The examples presented herein demonstrate how identifying potentially dangerous permissions in a target app that are atypical of permissions typically requested by the target app's application type can improve user security. Explanations of atypical app permissions presented to a user can further help a user make an informed decision as to whether certain apps really need certain permissions, and user prompts or other safeguards can help the user enable or disable such potentially dangerous permissions more easily.

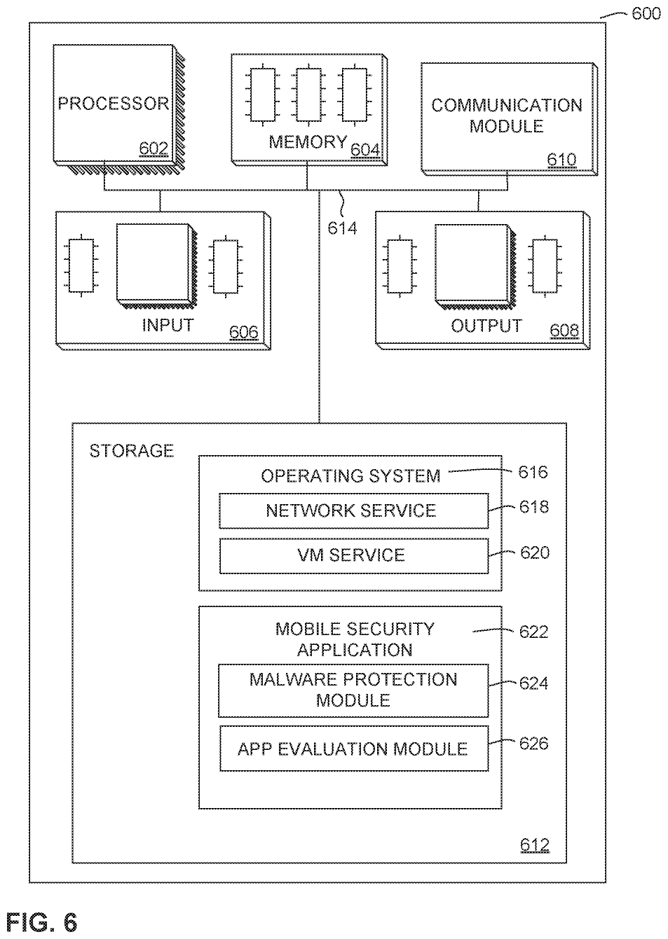

Although the smart phone, remote server, and other computerized devices are shown as specific computerized devices in various examples presented herein, in other embodiments they will have fewer, more, and/or other components or features, such as those described in FIG. 6. FIG. 6 is a computerized smart phone, consistent with an example embodiment of the invention. FIG. 6 illustrates only one particular example of network security device 600, and other computing devices may be used in other embodiments. Although network security device 600 is shown as a standalone computing device, device 600 may be any component or system that includes one or more processors or another suitable computing environment for executing software instructions in other examples, and need not include all of the elements shown here.

As shown in the specific example of FIG. 6, network security device 600 includes one or more processors 602, memory 604, one or more input devices 606, one or more output devices 608, one or more communication modules 610, and one or more storage devices 612. Device 600 in one example further includes an operating system 416 executable by network security device 600. The operating system includes in various examples services such as a network service 618 and a virtual machine service 620 such as a virtual server or various modules described herein. One or more applications, such as mobile security application 622 are also stored on storage device 412, and are executable by network security device 600.

Each of components 602, 604, 606, 608, 610, and 612 may be interconnected (physically, communicatively, and/or operatively) for inter-component communications, such as via one or more communications channels 614. In some examples, communication channels 614 include a system bus, network connection, inter-processor communication network, or any other channel for communicating data. Applications such as mobile security application 622 and operating system 616 may also communicate information with one another as well as with other components in device 600.

Processors 602, in one example, are configured to implement functionality and/or process instructions for execution within computing device 600. For example, processors 602 may be capable of processing instructions stored in storage device 612 or memory 604. Examples of processors 602 include any one or more of a microprocessor, a controller, a digital signal processor (DSP), an application specific integrated circuit (ASIC), a field-programmable gate array (FPGA), or similar discrete or integrated logic circuitry.

One or more storage devices 612 may be configured to store information within network security device 600 during operation. Storage device 612, in some examples, is known as a computer-readable storage medium. In some examples, storage device 612 comprises temporary memory, meaning that a primary purpose of storage device 612 is not long-term storage. Storage device 412 in some examples is a volatile memory, meaning that storage device 612 does not maintain stored contents when network security device 600 is turned off. In other examples, data is loaded from storage device 612 into memory 604 during operation. Examples of volatile memories include random access memories (RAM), dynamic random access memories (DRAM), static random access memories (SRAM), and other forms of volatile memories known in the art. In some examples, storage device 612 is used to store program instructions for execution by processor 602. Storage device 612 and memory 604, in various examples, are used by software or applications running on network security device 600 such as mobile security application 622 to temporarily store information during program execution.

Storage device 612, in some examples, includes one or more computer-readable storage media that may be configured to store larger amounts of information than volatile memory. Storage device 612 may further be configured for long-term storage of information. In some examples, storage devices 612 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Network security device 600, in some examples, also includes one or more communication modules 610. Computing device 600 in one example uses communication module 610 to communicate with external devices via one or more networks, such as one or more wireless networks. Communication module 610 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, network security device 600 uses communication module 610 to communicate with an external device such as via public network 102 of FIG. 1.

Network security device 600 also includes in one example one or more input devices 606. Input device 606, in some examples, is configured to receive input from a user through tactile, audio, or video input. Examples of input device 606 include a touchscreen display, a mouse, a keyboard, a voice-responsive system, a video camera, a microphone, or any other type of device for detecting input from a user.

One or more output devices 608 may also be included in computing device 600. Output device 608, in some examples, is configured to provide output to a user using tactile, audio, or video stimuli. Output device 608, in one example, includes a display, a sound card, a video graphics adapter card, or any other type of device for converting a signal into an appropriate form understandable to humans or machines. Additional examples of output device 608 include a speaker, a light-emitting diode (LED) display, a liquid crystal display (LCD), or any other type of device that can generate output to a user.

Network security device 600 may include operating system 616. Operating system 616, in some examples, controls the operation of components of network security device 600, and provides an interface from various applications such as mobile security application 622 to components of network security device 600. For example, operating system 616, in one example, facilitates the communication of various applications such as mobile security application 622 with processors 602, communication module 610, storage device 612, input device 606, and output device 608. Applications such as mobile security application 622 may include program instructions and/or data that are executable by computing device 600. As one example, mobile security application 622 is able to detect malicious network traffic, infected devices, and other threats using malware protection module 624, and to detect potentially dangerous permissions in target apps that are atypical of the target apps' application types via app evaluation module 626. These and other program instructions or modules may include instructions that cause network security device 600 to perform one or more of the other operations and actions described in the examples presented herein.

Although specific embodiments have been illustrated and described herein, any arrangement that achieves the same purpose, structure, or function may be substituted for the specific embodiments shown. This application is intended to cover any adaptations or variations of the example embodiments of the invention described herein. These and other embodiments are within the scope of the following claims and their equivalents.

1. A method of identifying anomalous system permissions in applications in a computing environment, comprising:
generating a statistical model at least in part from application permissions granted across a plurality of application types;
identifying one or more of the application permissions granted across a plurality of application types as potentially dangerous permissions; and
determining, using the generated statistical model, whether a target application has at least one potentially dangerous permission that is not statistically likely for a target application type of the target application.

2. The method of identifying anomalous system permissions in applications in a computing environment of claim 1, further comprising indicating to a user the determination of whether a target application has at least one potentially dangerous permission that is not statistically likely.

3. The method of identifying anomalous system permissions in applications in a computing environment of claim 2, wherein indicating to a user the determination of whether a target application has at least one potentially dangerous permission that is not statistically likely comprises indicating a metric or score indicating the degree of statistically unlikely dangerous permissions for the target application.

4. The method of identifying anomalous system permissions in applications in a computing environment of claim 2, wherein indicating to a user the determination of whether a target application has at least one potentially dangerous permission that is not statistically likely comprises providing an explanation indicating one or more statistically unlikely dangerous permissions for the target application.

5. The method of identifying anomalous system permissions in applications in a computing environment of claim 1, wherein determination of whether a dangerous permission is statistically likely for a target application type of a target application comprises determining whether a threshold probability of the dangerous permission being present in the target application type is met or exceeded.

6. The method of identifying anomalous system permissions in applications in a computing environment of claim 1, wherein generating a statistical model comprises observing the presence or absence of the plurality of application permissions in the plurality of application types.

7. The method of identifying anomalous system permissions in applications in a computing environment of claim 1, wherein generating a statistical model comprises observing the top or most likely requested permissions for the plurality of application types.

8. The method of identifying anomalous system permissions in applications in a computing environment of claim 1, wherein generating a statistical model comprises calculating a term frequency-inverse document frequency (TF-IDF) score for the plurality of application permissions in the plurality of application types.

9. The method of identifying anomalous system permissions in applications in a computing environment of claim 1, wherein the target application type of the target application comprises a determined application type, the determined application type determined by using the statistical model to evaluate application permissions of the target application.

10. The method of identifying anomalous system permissions in applications in a computing environment of claim 9, further comprising using the statistical model to determine whether the determined application type of the target application differs from a claimed application type of the target application.

11. The method of identifying anomalous system permissions in applications in a computing environment of claim 9, wherein determining the determined application type by using the statistical model to evaluate application permissions of the target application comprises determining one or more application types that are most statistically similar to the target application based on the generated statistical model of application permissions in application types.

12. A computing device operable to detect anomalous system permissions in applications, comprising:
a processor and a memory; and
a machine-readable medium with instructions stored thereon, the instructions when executed on the processor operable to cause the computing device to:
generate a statistical model at least in part from application permissions granted across a plurality of application types;
identify one or more of the application permissions granted across a plurality of application types as potentially dangerous permissions; and
determine, using the generated statistical model, whether a target application has at least one potentially dangerous permission that is not statistically likely for a target application type of the target application.

13. The computing device of claim 12, the instructions when executed further operable to cause the computing device to indicate to a user the determination of whether a target application has at least one potentially dangerous permission that is not statistically likely.

14. The computing device of claim 13, wherein indicating to a user the determination of whether a target application has at least one potentially dangerous permission that is not statistically likely comprises at least one of indicating a metric or score indicating the degree of statistically unlikely dangerous permissions for the target application and providing an explanation indicating one or more statistically unlikely dangerous permissions for the target application.

15. The computing device of claim 12, wherein determination of whether a dangerous permission is statistically likely for a target application type of a target application comprises determining whether a threshold probability of the dangerous permission being present in the target application type is met or exceeded.

16. The computing device of claim 12, wherein generating a statistical model comprises at least one of observing the presence or absence of the plurality of application permissions in the plurality of application types and observing the top or most likely requested permissions for the plurality of application types.

17. The computing device of claim 12, wherein generating a statistical model comprises calculating a term frequency-inverse document frequency (TF-IDF) score for the plurality of application permissions in the plurality of application types.

18. The computing device of claim 12, wherein the target application type of the target application comprises a determined application type, the determined application type determined by using the statistical model to evaluate application permissions of the target application.

19. The computing device of claim 18, the instructions when executed further operable to cause the computing device to determine, using the statistical model, whether the determined application type of the target application differs from a claimed application type of the target application.

20. The computing device of claim 18, wherein determining the determined application type by using the statistical model to evaluate application permissions of the target application comprises determining one or more application types that are most statistically similar to the target application based on the generated statistical model of application permissions in application types.
